(19) United States
(12) Patent Application Publication
(10) Pub. No.: US 2020/0275069 A1
(43) Pub. Date: Aug. 27, 2020

(54) DISPLAY METHOD AND DISPLAY SYSTEM

(71) Applicant: SEIKO EPSON CORPORATION, Tokyo (JP)

(72) Inventor: Masako TANAKA, Azumino-shi (JP)

(73) Assignee: SEIKO EPSON CORPORATION, Tokyo (JP)

(21) Appl. No.: 16/799,965

(22) Filed: Feb. 25, 2020

(30) Foreign Application Priority Data
Feb. 26, 2019 (JP) 2019-032414

(51) Int. Cl. H04N 9/31; G06F 3/042

(52) U.S. Cl. CPC H04N 9/3194; G06F 3/0425; H04N 9/3182

(57) ABSTRACT

A terminal apparatus acquires marker information representing the characteristics of a marker and generates association information that associates a display target image with the marker information. A projector detects the position and characteristics of the marker disposed on a screen, identifies an image associated with the marker based on the marker information corresponding to the characteristics of the detected marker and the association information, determines the position where the image is displayed based on the position of the detected marker, and displays the identified image in the determined display position.

The present application is based on, and claims priority from JP Application Serial Number 2019-032414, filed Feb. 26, 2019, the disclosure of which is hereby incorporated by reference herein in its entirety.

### BACKGROUND

### 1. Technical Field

The present disclosure relates to a display method and a display system.

### 2. Related Art

There has been a known method for detecting a marker disposed on a display surface and displaying an image associated with the detected marker.

For example, in an image display apparatus disclosed in JP-A-2007-11276, a camera captures an image of an object disposed on a projection surface on which an image is projected, and an object ID that identifies the object is extracted from the resultant captured image data, followed by acquisition of information on an attribute of the object associated with the extracted object ID. The image display apparatus further generates an image to be projected on the projection surface based on the acquired attribute information.

In a case where the number of images displayed on the display surface increases, however, it is difficult in some cases to prepare markers the number of which is equal to the number of images. In such cases, it has been desired to provide a method that can readily change the association of the markers with the images to readily change an image displayed on the display surface.

### SUMMARY

An aspect of the present disclosure is directed to a display method including causing a terminal apparatus to acquire marker information representing a characteristic of a marker, causing the terminal apparatus to generate association information that associates a display target image with the marker information, causing a detection apparatus to detect the marker disposed on a display surface, causing a display apparatus to extract the characteristic of the detected marker and identify an image associated with the marker based on the marker information corresponding to the extracted characteristic and the association information, causing the display apparatus to determine a position where the image is displayed based on a position of the detected marker, and causing the display apparatus to display the identified image in the determined display position.

In the display method described above, the terminal apparatus may acquire image data based on which the image is formed and generate the association information that associates the acquired image data with the marker information.

In the display method described above, the display apparatus may acquire the marker information corresponding to the extracted characteristic of the marker, and the display apparatus may acquire the image data associated with the acquired marker information from a storage that stores the image data in accordance with the association information in such a way that the image is associated with the marker information and display the image data.

In the display method described above, the detection apparatus may capture an image of the display surface to generate a captured image, and the display apparatus may detect the marker in the generated captured image, extract the characteristic of the marker, and detect the position of the marker.

In the display method described above, the display apparatus may detect movement of the marker based on a plurality of the generated captured images, and the display apparatus may determine at least one of the position where the image is displayed and a size of the displayed image based on the detected movement of the marker.

In the display method described above, the terminal apparatus may acquire the marker information from a captured image containing an image of the marker.

In the display method described above, the marker information may contain a shape or a color of an object used as the marker.

In the display method described above, the marker may contain an image code, and the marker information may contain information on a decoded code of the image code.

Another aspect of the present disclosure is directed to a display system including a terminal apparatus including an information acquirer that acquires marker information representing a characteristic of a marker and a generator that generates association information that associates a display target image with the marker information, and a display apparatus including a display section that displays an image on a display surface, a detector that detects a position and a characteristic of the marker disposed on the display surface, and a controller that identifies an image associated with the marker based on the marker information corresponding to the detected characteristic of the marker and the association information, determines a position where the image is displayed based on the detected position of the marker, and displays the identified image in the determined display position.

In the display system described above, the terminal apparatus may include a data acquirer that acquires image data based on which an image is formed, and the generator may generate the association information that associates the marker information acquired by the information acquirer with the image data acquired by the data acquirer.

The display system described above may further include a storage that stores the image data in accordance with the association information generated by the terminal apparatus in such a way that the image is associated with the marker information, and the display apparatus may acquire the marker information corresponding to the detected characteristic of the marker, acquire the image data associated with the acquired marker information from the storage, and display the acquired image data.

In the display system described above, the display apparatus may include an imager that captures an image of the display surface, and the controller may detect the marker in the captured image generated by the imager and detect the position and the characteristic of the marker.

In the display system described above, the controller may detect movement of the marker based on a plurality of the captured images and determine at least one of the position where the image is displayed and a size of the displayed image based on the detected movement of the marker.

In the display system described above, the terminal apparatus may include an imager, and the information acquirer may acquire the marker information from a captured image generated by the imager and containing the marker.

In the display system described above, the marker information may contain a shape or a color of an object used as the marker.

In the display system described above, the marker may contain an image code, and the marker information may contain information on a decoded code of the image code.

### BRIEF DESCRIPTION OF THE DRAWINGS

FIG. 1 is a perspective view of a display system according to a first embodiment.

FIG. 2 is a block diagram showing the configuration of a terminal apparatus.

FIG. 3 is a block diagram showing the configuration of a projector.

FIG. 4 shows the terminal apparatus and an image displayed on a screen.

FIG. 5 shows an image displayed on the screen.

FIG. 6 shows an image displayed on the screen.

FIG. 7 is a flowchart showing the action of the terminal apparatus.

FIG. 8 is a flowchart showing the action of the projector.

FIG. 9 shows the system configuration of a display system according to a second embodiment.

FIG. 10 is a flowchart showing the action of a server apparatus.

FIG. 11 is a flowchart showing the action of the projector.

### DESCRIPTION OF EXEMPLARY EMBODIMENTS

### First Embodiment

### 1. Overview of Display System

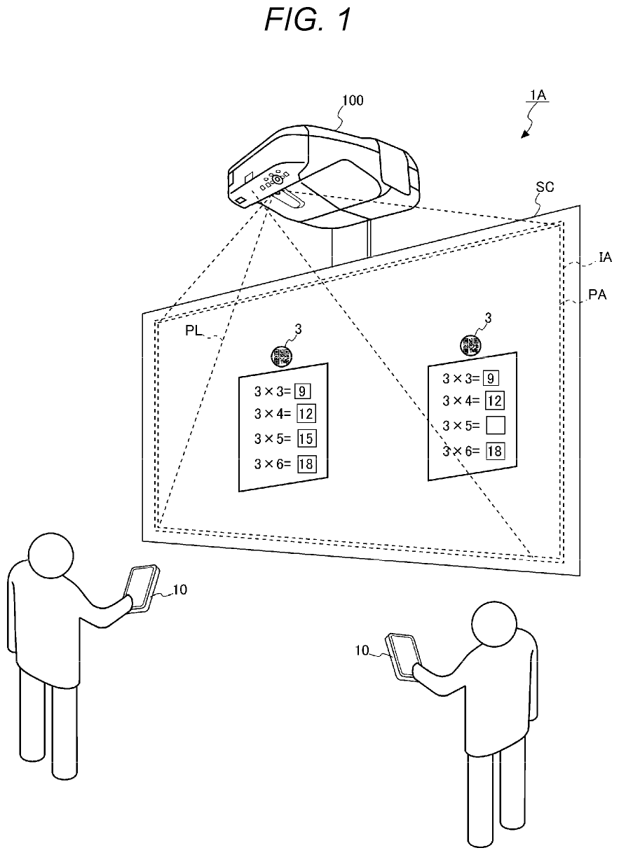

FIG. 1 is a perspective view of a display system 1A. The display system 1A includes a terminal apparatus 10 and a projector 100, which corresponds to an example of a display apparatus. The terminal apparatus 10 associates marker information 33, which represents characteristics of a marker 3, with an image that is a display target to be displayed by the projector 100. The projector 100 detects the position and characteristics of the marker 3 disposed on a screen SC, which is a display surface, identifies an image associated by the terminal apparatus 10 based on the characteristics of the detected marker 3, and displays the identified image in a position corresponding to the marker 3.

The position and shape of the marker 3 are optically detectable on the screen SC. FIG. 1 shows an example in which two markers 3 are disposed on the screen SC, but the number of markers 3 usable in the display system 1A is not limited to two and may instead be one or three or more.

The markers 3 may each, for example, be a pattern, a letter, or a figure displayed or formed in a target range IA of the screen SC. The target range IA represents the range over which a PJ imager 139 of the projector 100 performs imaging. The marker 3 may be an object independent of the screen SC. In the case where a plurality of markers 3 are used, at least one of the color, shape, and size of a marker 3 may differ from that of the other markers 3 so that the markers 3 are each recognizable. An image code may be formed on or attached onto the surface of the marker 3. The image code refers to a code systematically generated to express electronic data in a machine readable manner and includes, for example, a one-dimensional code, a two-dimensional code, or electronic watermark information. The one-dimensional code includes a barcode, and a two-dimensional code includes a QR code. The QR code is a registered trademark.

FIG. 1 shows a disc-shaped object on which a QR code is formed as an example of the marker 3. A user can manually move the marker 3 and fix the marker 3 in an arbitrary position on the screen SC. For example, the marker 3 includes an adhesive material and is therefore fixed to the screen SC based on adhesive force. Instead, for example, the screen SC may be made of a material that allows a magnet to attach thereto. In this case, the marker 3 may have a permanent magnet incorporated therein and may be fixable to the screen SC in an arbitrary position thereon. The marker 3 may still instead attach to the screen SC based on electrostatic force. In addition to the above, the method for fixing the marker 3 to the screen SC can be arbitrarily changed.

The terminal apparatus 10 is a terminal operated by the user and can, for example, be a smartphone, a tablet terminal, a PDA (personal digital assistant), or a notebook personal computer.

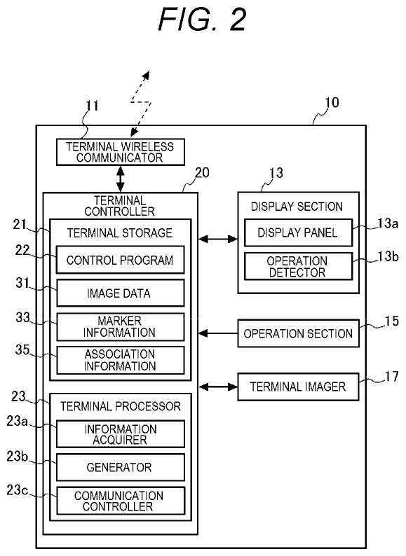

The terminal apparatus 10 acquires or generates the marker information 33, which represents the characteristics of the marker 3, and generates association information 35, which associates image data 31 to be displayed on the screen SC with the marker information 33. The image data 31, the marker information 33, and the association information 35 are shown in FIG. 2. The marker information 33 is information that allows optical identification of the marker 3. The terminal apparatus 10 optically detects the characteristics of the marker 3 based on the captured image data as a result of imaging of the marker 3 and generates the marker information 33 based on the optically detected characteristics of the marker 3. The marker information 33 will be described later in detail. The image data 31 is data selected by the user. The user may be a user of the terminal apparatus 10 or a user of another terminal apparatus 10.

The terminal apparatus 10 is wirelessly connected to the projector 100 and performs data communication with the projector 100. For example, the terminal apparatus 10 transmits the image data 31, the marker information 33, and the association information 35 to the projector 100.

The projector 100 generates image light PL and projects the generated image light PL toward the screen SC. An image based on the image light PL is thus formed on the screen SC. The image displayed when the image light PL is focused on the screen SC is called a projection image 5. The projection image 5 may be a still image or video images. The video images refer to what is called motion images. In the following description, a still image and video images are collectively called the projection image 5. The screen SC is, for example, a flat surface, such as a wall surface, or a curtain installed in the form of a hanging curtain. The screen SC may be one capable of reflecting the image light PL outputted from the projector 100 and forming an image. For example, a writable blackboard or whiteboard may be used as the screen SC.

An area where the projector 100 can project the image light PL is called a projection area PA. The projection area PA is a displayable area where the projector 100 can display an image. In a typical state in which the projector 100 is used, the projection is so performed that the projection area PA falls within the screen SC.

The projector 100, which includes the PJ imager 139, detects the marker 3 in the target range IA set on the screen

SC based on captured image data generated by the PJ imager 139. The projector 100 detects an object or a displayed content that coincides with the marker information 33 received from the terminal apparatus 10 to identify the marker 3. The target range IA may not coincide with the projection area PA, but the target range IA preferably contains the projection area PA. In the present embodiment, the case where the target range IA coincides with the projection area PA is presented by way of example. The projector 100 identifies the marker 3 detected in the target range IA in terms of position in the projection area PA.

The projector 100 detects the position and characteristics of the marker 3 disposed, formed, or displayed on the screen SC. The projector 100 identifies an image based on the marker information 33 associated with the characteristics of the detected marker 3 and determines a display position on the screen SC based on the position of the detected marker 3. The projector 100 displays the identified image in the determined display position.

### 2. Configuration of Terminal Apparatus

FIG. 2 is a block diagram showing the configuration of the terminal apparatus 10.

The terminal apparatus 10 includes a terminal wireless communicator 11, a display section 13, an operation section 15, a terminal imager 17, and a terminal controller 20.

The terminal wireless communicator 11 wirelessly communicates with an external apparatus including the projector 100 in accordance with a predetermined wireless communication standard. Employable examples of the predetermined wireless communication standard may include a wireless LAN, Bluetooth, UWB (ultrawide band), and infrared light communication. Bluetooth is a registered trademark.

The display section 13 includes a display panel 13a and an operation detector 13b.

The display panel 13a is formed, for example, of a liquid crystal panel or an organic EL (electro-luminescence) display. The display section 13 causes the display panel 13a to display a GUI (graphical user interface) image, such as a window, an icon, and a button, under the control of the terminal controller 20.

The operation detector 13b includes a touch sensor that detects touch operation performed on the display panel 13a. The touch sensor is not illustrated. The display panel 13a and the operation detector 13b function as a touch panel. The operation detector 13b detects a contact position where the user's finger or a touch pen has come into contact with the display panel 13a and outputs the coordinates on the display panel 13a that represent the detected contact position to the terminal controller 20. The terminal controller 20 identifies the inputted operation based on the coordinates inputted from the operation detector 13b and the display position where the GUI image is displayed on the display panel 13a and performs a variety of types of processing corresponding to the identified operation.

The operation section 15 includes hardware buttons that accept the user's operation. Examples of the hardware buttons include a power button of the terminal apparatus 10 and a shutter button via which a shutter of the terminal imager 17 is operated. When any of the buttons is operated, the operation section 15 generates an operation signal corresponding to the operated button and outputs the operation signal to the terminal controller 20.

The terminal imager 17 is what is called a digital camera and functions as an “imager” and an “information acquirer.” The terminal imager 17 includes an image sensor, such as a CCD (charge coupled device) and a CMOS (complementary metal-oxide semiconductor) device. The terminal imager 17 further includes a data processing circuit that generates captured image data from the light reception state of the image sensor. The terminal imager 17 may perform imaging by capturing visible light or light having a wavelength that does not belong to the visible region, such as infrared light and ultraviolet light. Upon acceptance of operation performed on the shutter button, the terminal imager 17 performs imaging to generate captured image data. The terminal imager 17 outputs the generated captured image data to the terminal controller 20.

The terminal controller 20 may include, for example, a computation apparatus that executes a program and achieve the function of the terminal controller 20 based on cooperation between hardware and software. The terminal controller 20 may instead be formed of hardware having a programmed computation function. In the present embodiment, the terminal controller 20 includes a terminal storage 21 and a terminal processor 23 by way of example.

The terminal storage 21 has a nonvolatile storage area that stores data in a nonvolatile manner. The nonvolatile storage area stores a control program 22, such as an OS (operating system) and an application program. The terminal storage 21 further has a volatile storage area. The volatile storage area functions as a work area where the terminal processor 23 operates. The volatile storage area stores the image data 31, the marker information 33, and the association information 35.

The image data 31 may be data stored in the terminal apparatus 10 in advance or data received from an external apparatus. Examples of the external apparatus may include a server apparatus and another terminal apparatus 10. The server apparatus may be a communicable apparatus via a wide-area network, such as the Internet, or an apparatus connected to a private network to which the terminal apparatus 10 is connected, such as a LAN (local area network). The server apparatus may instead be an apparatus connected to the same access point to which the terminal apparatus 10 is connected and capable of communication via the access point. The terminal wireless communicator 11, which functions to receive the image data 31 from the server apparatus or another terminal apparatus 10, and a communication controller 23c, which controls the terminal wireless communicator 11, function as a “data acquirer.” The communication controller 23c will be described later.

The image data 31 may instead be captured image data captured by the terminal imager 17 or data generated by an application program installed on the terminal apparatus 10. In this case, the terminal imager 17 functions as the “data acquirer”. Examples of the data generated by an application program may include a letter, a figure, a numeral, or a symbol drawn by the user via touch operation performed on the display panel 13a of the terminal apparatus 10. In this case, the terminal controller 20 that executes the application program functions as the “data acquirer.”

The terminal processor 23 is a computation apparatus formed, for example, of a CPU (central processing unit) or a microcomputer. The terminal processor 23 executes the control program 22 stored in the terminal storage 21 to control each portion of the terminal apparatus 10. The terminal processor 23 may be formed of a single processor or can be formed of a plurality of processors. The terminal processor 23 can be formed of an SoC (system on chip) device integrated with part or entirety of the terminal storage 21 and other circuits. The terminal processor 23 may instead be the combination of a CPU that executes a program and a DSP (digital signal processor) that performs predetermined computation. The terminal processor 23 may still instead have a configuration in which all the functions of the terminal processor 23 are implemented in hardware or a configuration using a programmable device.

The terminal controller 20, in which the terminal processor 23 executes an instruction set written in the control program 22 to perform data computation and control, functions as an information acquirer 23a, a generator 23b, and the communication controller 23c.

The information acquirer 23a along with the terminal imager 17 functions as the “information acquirer.” The information acquirer 23a analyzes the captured image data as a result of imaging of the marker 3 to extract the marker information 33 representing the characteristics of the marker 3. The characteristics of the marker 3 refers to optically identifiable attributes, such as the apparent color, pattern, shape, and size of the marker 3. The optically identifiable attributes are not limited to attributes detectable and identifiable by using visible light and include attributes detectable and identifiable by using infrared light or ultraviolet light.

First, upon reception of the request to register a marker 3 issued by touch operation performed on the display panel 13a, the information acquirer 23a causes the terminal imager 17 to perform imaging to capture an image of the marker 3. The user places a marker 3 that the user desires to register in the imageable range of the terminal imager 17 and presses the shutter button. When the shutter button is pressed, the information acquirer 23a causes the terminal imager 17 to perform the imaging. The information acquirer 23a causes the terminal storage 21 to temporarily store the captured image data inputted from the terminal imager 17.

The information acquirer 23a analyzes the captured image data to generate the marker information 33 representing the characteristics of the marker 3. In the present embodiment, the description will be made of a case where an object to which a QR code is attached is used as the marker 3. The information acquirer 23a extracts an image of the two-dimensional code from the captured image data and decodes the extracted image to acquire code information. The information acquirer 23a causes the terminal storage 21 to store the acquired code information as the marker information 33.

In a case where an object to which no image code, such as a QR code, is attached is used as a marker 3, the information acquirer 23a may analyze the captured image data to detect apparent characteristics of the marker 3, such as the color, pattern, shape, and size thereof, as the marker information 33.

For example, the information acquirer 23a may directly use the captured image data acquired over the imaging range over which an image of the marker 3 has been captured as the marker information 33. In a case where the color or pattern of the marker 3 is used as the marker information 33, the information acquirer 23a may identify the color, color arrangement, or any other factor of the marker 3 by comparison with the color of a sample image prepared in advance. In a case where the shape or the size of the marker 3 is used as the marker information 33, the information acquirer 23a may detect the contour of the marker 3 by performing edge extraction and identify the shape or the size of the marker 3 based on the detected contour to generate the marker information 33.

The generator 23b generates the association information 35, which associates the image data 31 with the marker information 33.

First, upon acceptance of the request to select a display target image issued by touch operation performed on the display panel 13a, the generator 23b causes the display panel 13a to display thumbnail images of image data 31 stored in the terminal storage 21. In a case where the thumbnail images contain no display target image that the user desires to cause the projector 100 to display, the user operates the terminal apparatus 10 to access, for example, a server apparatus connected to the communication network and downloads image data 31 from the server apparatus. Instead, image data 31 transmitted from another terminal apparatus 10 may be used as the display target image, or the user may perform touch operation on the display panel 13a to cause the terminal apparatus 10 to generate image data 31.

Upon selection of image data 31, the generator 23b generates association information 35 that associates the selected image data 31 with the marker information 33. Identification information that identifies the image data 31 is set in the image data 31, and identification information that identifies the marker information 33 is set in the marker information 33. Identification information that identifies the image data 31 is called image identification information, and identification information that identifies the marker information 33 is called marker identification information. The generator 23b associates the image identification information with the marker identification information to generate the association information 35.

The image identification information may, for example, be a file name that can identify the image data 31 or may be imparted by the generator 23b. The marker identification information may be imparted by the generator 23b.

Upon acceptance of the request to register a display target image issued by touch operation performed on the display panel 13a, the generator 23b causes the display panel 13a to display thumbnail images of image data 31 which is stored in the terminal storage 21 and with which the marker identification information has been associated.

When any one of thumbnail images is selected by the user, the generator 23b reads the image data 31, the marker information 33, and the association information 35 from the terminal storage 21 and outputs them to the communication controller 23c. The image data 31 is data corresponding to the selected thumbnail image, and the association information is information containing the image identification information on the image data 31. The marker information 33 is marker information 33 corresponding to the marker identification information contained in the association information 35.

The communication controller 23c controls the terminal wireless communicator 11 to perform wireless communication with the projector 100. The communication controller 23c transmits the image data 31, the marker information 33, and the association information 35 inputted from the generator 23b to the projector 100. The image data 31, the marker information 33, and the association information transmitted to the projector 100 are hereinafter collectively called registration information.

When the image data 31 associated with the marker information 33 is changed, the generator 23b outputs the registration information containing the changed image data 31, marker information 33, and association information 35 to the communication controller 23c again. The communication controller 23c transmits the inputted registration information to the projector 100.

3. Configuration of projector

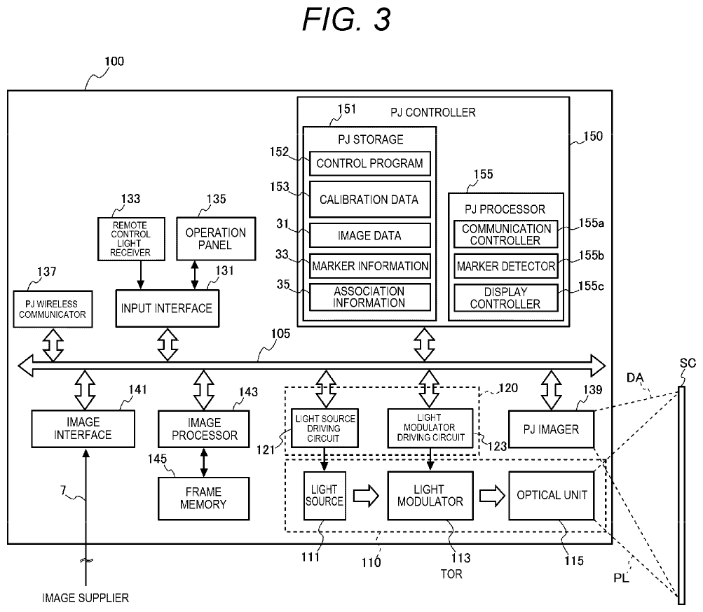

FIG. 3 is a block diagram showing the configuration of the projector 100. The configuration of the projector 100 will be described with reference to FIG. 3.

The projector 100 includes a projection section 110 and a driver 120. The projection section 110 corresponds to an example of a “display section” and includes a light source 111, a light modulator 113, and an optical unit 115. The driver 120 includes a light source driving circuit 121 and a light modulator driving circuit 123. The light source driving circuit 121 and the light modulator driving circuit 123 are connected to a bus 105.

The light source 111 is formed of a solid-state light source, such as an LED and a laser light source. The light source 111 may instead be a lamp, such as a halogen lamp, a xenon lamp, and an ultrahigh-pressure mercury lamp. The light source 111 emits light when driven by the light source driving circuit 121. The light source driving circuit 121 is coupled to the bus 105 and supplies the light source 111 with electric power under the control of a PJ controller 150 coupled to the same bus 105.

The light modulator 113, specifically, a light modulating device modulates the light emitted from the light source 111 to generate the image light PL and outputs the generated image light PL to the optical unit 115. The light modulating device provided in the light modulator 113 may, for example, be a transmissive liquid crystal light valve, a reflective liquid crystal light valve, or a digital mirror device. In the present embodiment, the description will be made of a case where the light modulating device is a transmissive light modulating device.

The light modulator 113 is coupled to the light modulator driving circuit 123. The light modulator driving circuit 123 drives the light modulating device in such a way that the transmittance provided by the light modulating device corresponds to the image data 31, based on which the image light PL is generated.

The optical unit 115 includes optical elements, such as a lens and a mirror, and projects the image light PL generated by the light modulator 113 on the screen SC. The image light PL is focused on the screen SC, and the projection image 5 corresponding to the image light PL is displayed on the screen SC.

The projector 100 includes an input interface 131, a remote control light receiver 133, and an operation panel 135. The input interface 131 accepts an input to the projector 100. The input interface 131 is coupled to the remote control light receiver 133, which receives an infrared signal transmitted from a remote control that is not shown, and the operation panel 135, which is provided on a main body of the projector 100. The input interface 131 decodes the signal received by the remote control light receiver 133 to detect operation performed on the remote control. The input interface 131 further detects operation performed on the operation panel 135. The input interface 131 outputs data representing the content of the operation to the PJ controller 150.

The projector 100 includes a PJ wireless communicator 137 and a PJ imager 139. The PJ wireless communicator 137 wirelessly communicates with an external apparatus including the terminal apparatus 10 in accordance with a predetermined wireless communication standard. Employable examples of the predetermined wireless communication standard may include a wireless LAN, Bluetooth, UWB, and infrared light communication.

The PJ imager 139 is what is called a digital camera and corresponds to a “detection apparatus.” The PJ imager 139 along with a marker detector 155b, which will be described later, also functions as a “detector.” The PJ imager 139 includes an image sensor, such as a CMOS device and a CCD, and a data processing circuit that generates captured image data from the light reception state of the image sensor. The PJ imager 139 may perform imaging by capturing visible light or light having a wavelength that does not belong to the visible region, such as infrared light and ultraviolet light.

The PJ imager 139 performs the imaging to generate captured image data and outputs the generated captured image data to the PJ controller 150 under the control of the PJ controller 150. The imaging range, that is, the angle of view of the PJ imager 139 is a range containing the target range IA set on the screen SC.

The projector 100 includes an image interface 141, an image processor 143, and a frame memory 145. The image interface 141 and the image processor 143 are coupled to the bus 105.

The image interface 141 is an interface to which the image data 31 is inputted and includes a connector to which a cable 7 is coupled and an interface circuit that receives the image data 31 via the cable 7.

An image supplier that supplies the image data 31 is connectable to the image interface 141. The image data 31 handled by the projector 100 may be motion image data or still image data and may be formatted in an arbitrary data format.

The frame memory 145 is coupled to the image processor 143. The image processor 143 develops the image data inputted from the image interface 141 in the frame memory 145 and processes the developed imaged data. Examples of the processes carried out by the image processor 143 include a shape distortion correction process of correcting shape distortion of the projection image 5 and an OSD process of superimposing an OSD (on-screen display) image on the projection image 5. The image processor 143 may further carry out an image adjustment process of adjusting the luminance and color tone of the image data and a resolution conversion process of adjusting the aspect ratio and resolution of the image data in accordance with those of the light modulator 113.

Having completed the image processing, the image processor 143 outputs the processed image data to the light modulator driving circuit 123. The light modulator driving circuit 123 generates a drive signal that drives the light modulator 113 based on the inputted image data. The light modulator driving circuit 123 drives the light modulating device in the light modulator 113 based on the generated drive signal in such a way that transmittance corresponding to the image data is achieved. The light outputted from the light source 111 passes through the light modulating device in which an image is formed and is modulated by the light modulating device into the image light PL, and the modulated image light PL is projected via the optical unit 115 on the screen SC.

The projector 100 includes the PJ controller 150, which controls each portion of the projector 100. The PJ controller 150 may achieve the function of the PJ controller 150 based on cooperation between hardware and software. The PJ controller 150 may instead be formed of hardware having a programmed computation function. In the present embodiment, the description will be made of a configuration in which the PJ controller 150 includes a PJ storage 151 and a PJ processor 155 by way of example.

In the first embodiment, the PJ storage 151 corresponds to a “storage.” The PJ storage 151 has a nonvolatile storage area that stores data in a nonvolatile manner. The nonvolatile storage area stores a control program 152 executed by the PJ processor 15, such as an OS and an application program, and calibration data 153.

The PJ storage 151 further has a volatile storage area that stores data in a volatile manner. The volatile storage area acts as a work area where the PJ processor 155 operates. The volatile storage area temporarily stores the image data 31, the marker information 33, and the association information 35, which form the registration information received from the terminal apparatus 10.

The calibration data 135 is data that associates the coordinates in the captured image data generated by the PJ imager 139 with the coordinates in the frame memory 145. The coordinates in the captured image data are called imaging coordinates, and the coordinates in the frame memory 145 are called memory coordinates. The calibration data 153 allows conversion of the imaging coordinates in the captured image data into the corresponding memory coordinates in the frame memory 145. The calibration data 153 is generated, for example, when the projector 100 is manufactured and stored in the PJ storage 151.

The PJ processor 155 is a computation apparatus formed, for example, of a CPU or a microcomputer. The PJ processor 155 maybe formed of a single processor or a plurality of processors. The PJ processor 155 may be formed of an SoC device integrated with part or entirety of the PJ processor 155 and other circuits. The PJ processor 155 may instead be the combination of a CPU that executes a program and a DSP that performs predetermined computation. The PJ processor 155 may still instead have a configuration in which all the functions of the PJ processor 155 are implemented in hardware or a configuration using a programmable device. The PJ processor 155 may also function as the image processor 143. That is, the PJ processor 155 may provide the function of the image processor 143.

The PJ controller 150, specifically, the PJ processor 155 executes an instruction set written in the control program 152 to perform data computation and control. The PJ controller 150 thus functions as a communication controller 155a, a marker detector 155b, and a display controller 155c.

The communication controller 155a controls the PJ wireless communicator 137 to perform wireless communication with the terminal apparatus 10. The communication controller 155a controls the PJ wireless communicator 137 to receive, for example, the registration information transmitted from the terminal apparatus 10. The registration information is stored in the PJ storage 151 under the control of the PJ controller 150.

The PJ controller 150 associates the image data 31 and the marker information 33 contained in the received registration information with each other and causes the PJ storage 151 to store the associated data and information. The association information 35 does not need to be stored in the PJ storage 151 as long as the image data 31 and the marker information 33 are associated with each other and stored in the PJ storage 151, but the association information 35 may be stored in the PJ storage 151. In the present embodiment, the description will be made of a case where the association information 35 is not deleted but is stored in the PJ storage 151.

The marker detector 155b along with the PJ imager 139 functions as the “detector,” detects the position of the marker 3 disposed on the screen SC, and extracts the characteristics of the marker 3.

The marker detector 155b causes the PJ imager 139 to perform the imaging. The PJ imager 139 captures an image over the range containing the target range IA to generate captured image data and outputs the generated captured image data to the marker detector 155b. The marker detector 155b causes the PJ storage 151 to store the inputted captured image data.

The marker detector 155b reads the captured image data from the PJ storage 151 and analyzes the read captured image data to detect an image of the marker 3. The marker detector 155b detects a range having characteristics that coincide with the characteristics of the marker 3 indicated by the marker information 33 to detect an image of the marker 3.

Having detected an image of the marker 3, the marker detector 155b extracts the characteristics of the marker 3 from the detected image of the marker 3. The marker 3 in the present embodiment has a two-dimensional code attached thereto. The marker detector 155b therefore converts the captured image data into a binarized image and extracts the two-dimensional code from the converted binarized image. The marker detector 155b then decodes the extracted two-dimensional code to acquire code information. The marker detector 155b evaluates whether or not marker information 33 that coincides with the acquired code information is stored in the PJ storage 151. In a case where marker information 33 that coincides with the acquired code information is stored in the PJ storage 151, the marker detector 155b outputs the marker information 33 that coincides with the code information and range information representing the range of the captured image data from which the two-dimensional code is extracted to the display controller 155c. The range information is information identified by the imaging coordinates.

In a case where no image code is attached to the marker 3, the marker detector 155b searches the captured image data and detects an image range having characteristics that coincide with the characteristics indicted by the marker information 33. The marker detector 155b detects, for example, a range over which an image of an object having the color or shape indicated by the marker information 33 is captured as the range over which an image of the marker 3 is captured. The marker detector 155b outputs the range information representing the detected range and the marker information 33 used to detect the range information to the display controller 155c.

The display controller 155c functions as a “controller,” acquires the image data 31 associated with the marker information 33 on the marker 3 detected by the marker detector 155b, and determines a display position where the acquired image data 31 is displayed.

The display controller 155c first converts the imaging coordinates that form the range information representing the position of the marker 3 detected by the marker detector 155b into the memory coordinates, which are coordinates in the frame memory 145. The display controller 155c reads the calibration data 153 from the PJ storage 151 and converts the imaging coordinates into the memory coordinates based on the read calibration data 153.

The display controller 155c then reads the image data 31 associated with the marker information 33 from the PJ storage 151. The display controller 155c then determines the memory coordinates in the frame memory 145 where the image data 31 is developed based on the converted memory coordinates of the marker 3 and the size of the read image data 31. For example, the display controller 155c determines the memory coordinates where the image data 31 is developed in such a way that the marker 3 is located at the center of the image data 31 in the horizontal direction. The display controller 155c instead determines the memory coordinates where the image data 31 is developed in such a way that the marker 3 and the image data 31 are separate from each other by a preset distance in the vertical direction and the image data 31 is located below the marker 3.

The display controller 155c outputs the image data 31 and the determined memory coordinates to the image processor 143 and causes the image processor 143 to perform image processing. The image processor 143 develops the inputted image data 31 at the coordinates in the frame memory 145 indicated by the inputted memory coordinates.

In the case where a plurality of markers 3 are fixed to the screen SC, as shown in FIG. 1, and the marker detector 155b detects the plurality of markers 3, the image data 31 associated with each of the markers 3 is developed in the frame memory 145. The image processor 143 performs image processing on the developed image data 31, reads the processed image data 31 from the frame memory 145, and outputs the read image data 31 to the light modulator driving circuit 123.

The light modulator driving circuit 123 generates a drive signal based on the inputted image data 31 and drives the light modulating device in the light modulator 113 based on the generated drive signal. The transmittance provided by the light modulating device is therefore so controlled as to be the transmittance corresponding to the image data 31. The light outputted from the light source 111 passes through the light modulating device in which an image is formed and is converted by the light modulating device into the image light PL, and the generated image light PL is projected via the optical unit 115 on the screen SC.

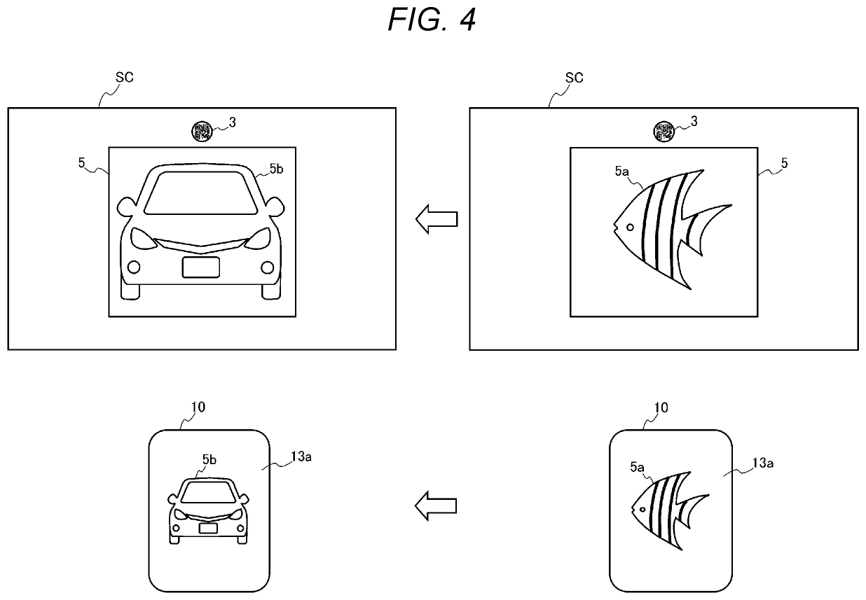

FIG. 4 shows the terminal apparatus 10 and an image displayed on the screen SC.

For example, it is assumed that an image displayed on the display panel 13a of the terminal apparatus 10 is changed by the user's operation from a fish image 5a to a car image 5b.

The terminal controller 20 changes the association information 35 in response to the change in the image on the display panel 13a from the fish image 5a to the car image 5b. That is, the terminal controller 20 changes the image data 31 to be associated with the marker information 33 from image data 31 on the fish image 5a to image data 31 on the car image 5b.

In a case where a plurality of markers 3, that is, a plurality of sets of marker information 33 are registered in the terminal apparatus 10, the terminal controller 20 may display an image of a marker 3 relating to the marker information 33 image data 31 associated with which is changed on the display panel 13a. The image of the marker 3 is an image generated based on the captured image data captured when the terminal imager 17 captures an image of the marker 3 at the registration of the marker information 33.

The terminal controller 20 overwrites the association information 35, changes the image data 31 associated with the marker information 33, and transmits the registration information containing the changed image data 31, marker information 33, and association information 35 to the projector 100 again.

Upon reception of the registration information from the terminal apparatus 10, the PJ controller 150 causes the PJ storage 151 to store the received registration information. The image data 31 associated with the marker information 33 is thus updated in the projector 100.

Having caused the PJ storage 151 to store the registration information, the PJ controller 150 analyzes the captured image data from the PJ imager 139 to evaluate whether or not a marker 3 corresponding to the marker information 33 has been detected. In a case where a marker 3 corresponding to the marker information 33 has been detected, the PJ controller 150 reads image data 31 associated with the marker information 33 from the PJ storage 151 and controls the image processor 143, the projection section 110, and the driver 120 to cause them to display the image data 31 on the screen SC. The image displayed by the projector 100 on the screen SC is therefore changed from the fish image 5a to the car image 5b.

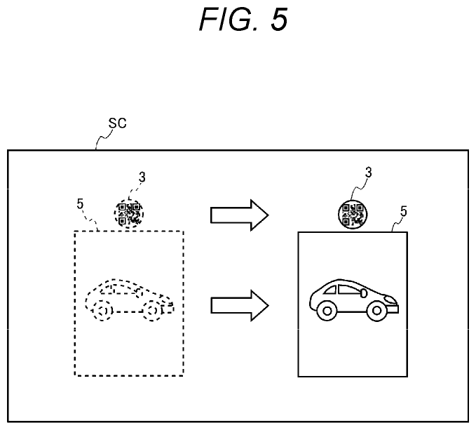

FIG. 5 shows an image displayed on the screen SC. In particular, FIG. 5 shows a change in the position where the projection image 5 is displayed when the marker 3 is moved.

The marker 3 and the projection image 5 drawn in the broken lines in FIG. 5 show the marker 3 and the projection image 5 before the positions thereof are moved. The marker 3 and the projection image 5 drawn in the solid lines in FIG. 5 show the marker 3 and the projection image 5 after the positions thereof are moved.

The PJ controller 150 detects the movement of the marker 3 based on a plurality of sets of captured image data and determines the position where the projection image 5 is displayed based on the detected movement of the marker 3.

The PJ imager 139 performs imaging at fixed intervals set in advance to generate the captured image data. The marker detector 155b can therefore detect the movement of the marker 3 by detecting the marker 3 in the captured image data continuously captured by the PJ imager 139. The display controller 155c changes the position where the image data 31 is displayed in correspondence with the change in the range information inputted from the marker detector 155b and representing the position of the marker 3. The user can therefore move the position where the projection image 5 is displayed on the screen SC by moving the position of the marker 3 disposed on the screen SC.

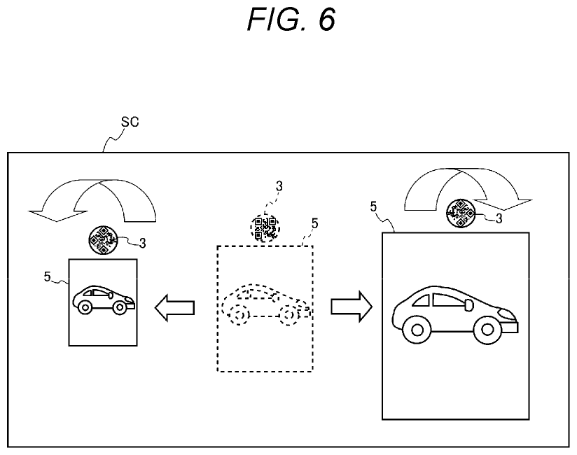

FIG. 6 shows an image displayed on the screen SC. In particular, FIG. 6 shows a change in the image when the marker 3 is rotated.

The marker 3 and the projection image 5 drawn in the broken lines in FIG. 6 show the projection image 5 before the marker 3 is rotated. The marker 3 and the projection image 5 drawn in the solid lines in FIG. 6 show the projection image 5 after the marker 3 is rotated.

The PJ controller 150 detects the movement of the marker 3 based on a plurality of sets of captured image data and determines the size at which the projection image 5 is displayed based on the detected movement of the marker 3.

The marker 3 in the present embodiment has a QR code attached thereto. Capturing an image of the QR code attached to the marker 3 with the PJ imager 139 and analyzing the captured image data allows detection of the rotation of the marker 3 as the movement thereof. The QR code has a plurality of patterns for position detection formed therein. Analyzing the captured image data to identify the arrangement of the patterns for position detection allows detection of the rotation of the QR code attached to the marker 3 and the direction of the rotation.

The marker detector 155b detects images of the marker 3 in the plurality of sets of captured image data captured at the fixed intervals and compares the detected images of the marker 3 with each other to detect the direction and angle of the rotation of the marker 3. The direction and angle of the rotation of the marker 3 detected by the marker detector 155b are inputted to the display controller 155c. The display controller 155c decreases or increases the size of the image data 31 based on the inputted direction and angle of the rotation.

For example, when the marker detector 155b detects leftward rotation of the marker 3, that is, counterclockwise rotation of the marker 3 in the front view of the screen SC, as shown in FIG. 6, the display controller 155c decreases the size of the image data 31 to be developed in the frame memory 145. The factor at which the image data 31 is decreased is set in proportion to the angle of the rotation of the marker 3 detected by the marker detector 155b. For example, the display controller 155c sets the factor at which the image data 31 is decreased at a greater value when the marker 3 is rotated by a greater angle.

In a case where the marker detector 155b detects rightward rotation of the marker 3, that is, clockwise rotation of the marker 3 in the front view of the screen SC, as shown in FIG. 6, the display controller 155c increases the size of the image data 31 to be developed in the frame memory 145. The factor at which the image data 31 is increased is set in proportion to the angle of the rotation of the marker 3 detected by the marker detector 155b. The display controller 155c sets the factor at which the image data 31 is increased at a greater value when the marker 3 is rotated by a greater angle.

### 4. Action of Terminal Apparatus

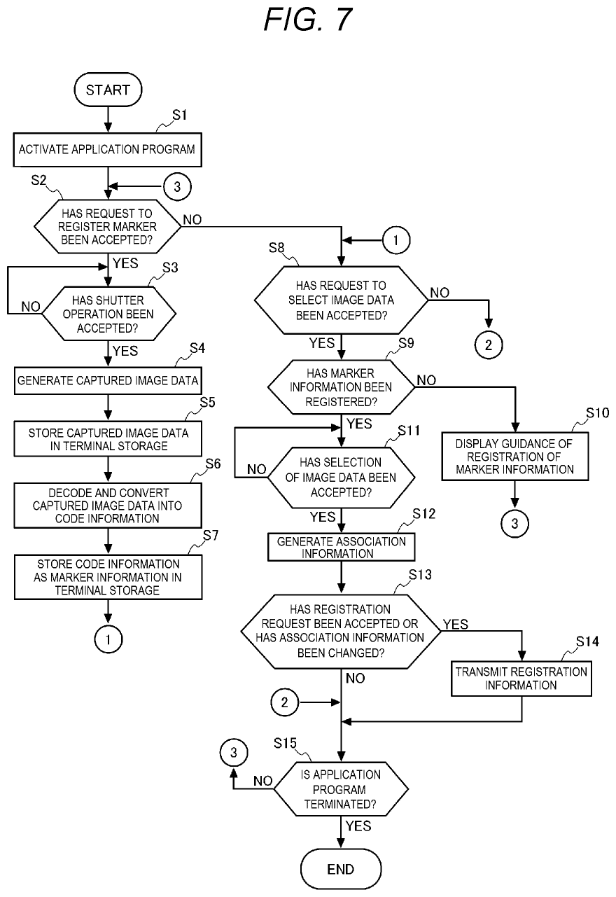

FIG. 7 is a flowchart showing the action of the terminal apparatus 10.

The action of the terminal apparatus 10 will be described with reference to the flowchart shown in FIG. 7.

When an application program contained in the control program 22 is selected via touch operation performed on the terminal apparatus 10, the terminal controller 20, specifically, the terminal processor 23 executes the selected application program. The application program is thus activated (step S1).

The terminal controller 20 then evaluates whether or not the request to register a marker 3 has been accepted (step S2). In a case where the request to register a marker 3 has been accepted (YES in step S2), the terminal controller 20 first causes the display panel 13a to display guidance that guides the user in registration of a marker 3. The terminal controller 20 then evaluates whether or not operation performed on the shutter button has been accepted (step S3). In a case where no operation performed on the shutter button has been accepted (NO in step S3), the terminal controller 20 waits until operation performed on the shutter button is accepted.

In a case where operation performed on the shutter button has been accepted (YES in step S3), the terminal controller 20 causes the terminal imager 17 to perform imaging to generate captured image data (step S4). The terminal controller 20 causes the terminal storage 21 to store the captured image data generated by the terminal controller 20 (step S5).

The terminal controller 20 reads the captured image data from the terminal storage 21, decodes the read captured image data, and converts the decoded captured image data into code information (step S6). The terminal controller 20 causes the terminal storage 21 to store the converted code information as the marker information 33 (step S7).

In a case where no request to register a marker 3 has been accepted (NO in step S2), or when the process in step S7 is completed, the terminal controller 20 evaluates whether or not the request to select image data 31 has been accepted (step S8). Image data 31 selected in step S8 is data based on which the projector 100 displays an image on the screen SC. The image data 31 may be data generated by a function of the application program activated in step S1. The image data 31 may instead be data downloaded from an external apparatus, such as a server apparatus, under the control of the application program activated in step S1.

In a case where no request to select the image data 31 has been accepted (NO in step S8), the terminal controller 20 proceeds to the evaluation in step 515. Ina case the request to select the image data 31 has been accepted (YES instep S8), the terminal controller 20 evaluates whether or not the marker information 33 has been registered (step S9). In a case where no marker information 33 has been registered (NO in step S9), the terminal controller 20 causes the display panel 13a to display guidance of request to register the marker information (step S10) and proceeds to step S2.

In a case where the marker information 33 has been registered (YES in step S9), the terminal controller 20 causes the display panel 13a to display thumbnail image of image data 31 and accepts operation of selecting image data 31 (S11). In a case where no operation of selecting image data 31 has been accepted (NO in step S11), the terminal controller 20 waits until the operation is accepted. Upon reception of the operation of selecting image data 31, the terminal controller associates the image identification information that identifies the selected image data 31 with the marker identification information that identifies the marker information 33 to generate the association information 35 (step S12). The terminal controller 20 causes the terminal storage 21 to store the generated association information 35.

The terminal controller 20 then evaluates whether or not the request to register image data 31 has been accepted or the association information 35 has been changed (step S13). In a case no request to register image data 31 has been accepted or the association information 35 has not been changed (NO in step S13), the terminal controller 20 proceeds to the evaluation in step S15.

In a case where the request to register image data 31 has been accepted or the association information 35 has been changed (YES in step S13), the terminal controller 20 transmits the registration information containing the image data 31, the marker information 33, and the association information 35 to the projector 100 (step S14).

The terminal controller 20 then evaluate whether or not termination operation of terminating the application program has been accepted (step S15). In a case where the termination operation of terminating the application program has been accepted (YES in step S15), the terminal controller 20 terminates the process procedure. In a case where no termination operation of terminating the application program has been accepted (NO in step S15), the terminal controller 20 returns to the evaluation in step S2.

### 5. Action of Projector

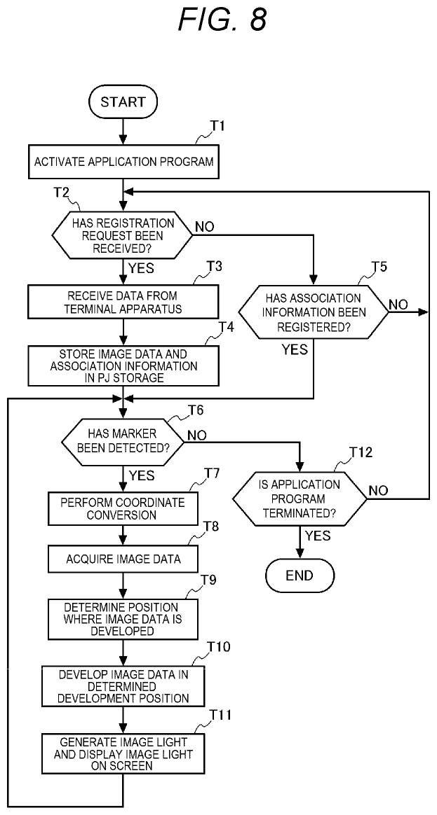

FIG. 8 is a flowchart showing the action of the projector 100.

The action of the projector 100 will be described with reference to the flowchart shown in FIG. 8. When the remote control is so operated that an application program contained in the control program 152 is selected, the projector 100, specifically, the PJ controller 150 executes the selected application program. The application program is thus activated (step T1).

The PJ controller 150 then evaluates whether or not the request to register registration information has been received from the terminal apparatus 10 (step T2). In a case where no registration request has been received (NO in step T2), the PJ controller 150 evaluates whether or not association information 35 is stored in the PJ storage 151 (step T5).

In a case where association information 35 is stored in the PJ storage 151 (YES in step T5), the PJ controller 150 proceeds to evaluation in step T6. In a case where no association information 35 is stored in the PJ storage 151 (NO in step T5), the PJ controller 150 returns to the evaluation in step T2 and evaluates whether or not the request to register registration information has been received from the terminal apparatus 10.

Upon reception of the request to register registration information from the terminal apparatus 10 (YES in step T2), the PJ controller 150 receives registration information from the terminal apparatus 10 (step T3). The PJ controller 150 associates the image data 31 with the marker information 33 in accordance with the received association information 35 and causes the PJ storage 151 to store the associated image data 31 and marker information 33 (step T4).

The PJ controller 150 then analyzes captured image data captured by the PJ imager 139 to detect a marker 3 having characteristics that coincide with the characteristics contained in the marker information 33 stored in the PJ storage 151 (step T6). Specifically, the PJ controller 150 converts the captured image data into a binarized image and extracts a two-dimensional code from the converted binarized image. The PJ controller 150 decodes the extracted two-dimensional code to acquire code information and evaluates whether or not marker information 33 that coincides with the acquired code information is stored in the PJ storage 151. In a case where marker information 33 that coincides with the acquired code information is stored in the PJ storage 151, the PJ controller 150 determines that a marker 3 has been detected. In a case where no marker information 33 that coincides with the acquired code information is stored in the PJ storage 151, the PJ controller 150 determines that no marker 3 has been detected.

In a case where no marker 3 has been detected (NO in step T6), the PJ controller 150 proceeds to step T12, where the PJ controller 150 evaluates whether or not operation of terminating the application program has been accepted (step T12). In a case where the operation of terminating the application program has been accepted (YES in step T12), the PJ controller 150 terminates the process procedure. In a case where no operation of terminating the application program has been accepted (NO in step T12), the PJ controller 150 returns to the evaluation in step T2.

In a case where a marker 3 has been detected (YES in step T6), the PJ controller 150 performs coordinate conversion of the imaging coordinates where the code information has been detected and which show the range of the captured image data into the memory coordinates based on the calibration data 153 (step T7).

The PJ controller 150 then acquires the extracted code information, that is, the image data 31 associated with the marker information 33 from the PJ storage 151 (step T8). The PJ controller 150 then determines the position in the frame memory 145 where the image data 31 is developed based on the size of the acquired image data 31 and the memory coordinates as a result of the coordinate conversion. The PJ controller 150 generates the memory coordinates in the frame memory 145 that represent the development position and outputs the generated memory coordinates and the image data 31 to the image processor 143.

The image processor 143 develops the inputted image data 31 at the memory coordinates in the frame memory 145 that have been inputted from the PJ controller 150. In the case where a plurality of markers 3 are disposed on the screen SC and a plurality of sets of marker information 33 are detected from the captured image data, image data 31 associated with the other markers 3 are also developed in the frame memory 145. The image processor 143 reads the image data 31 developed in the frame memory 145 and outputs the read image data 31 to the light modulator driving circuit 123. Image light corresponding to the read image data 31 is then generated by the projection section 110 and projected on the screen SC (step T11). The PJ controller 150 then returns to the evaluation in step T6.

As described above, in the display system 1A according to the first embodiment, the terminal apparatus 10 acquires the marker information 33 representing the characteristics of the marker 3 and generates the association information 35 that associates a display target image with the marker information 33.

The projector 100 detects the marker 3 disposed on the screen SC, extracts the characteristics of the detected marker 3, and identifies an image associated with the marker 3 based on the marker information 33 corresponding to the extracted characteristics and the association information 35. The projector 100 determines the position where the image is displayed based on the position of the detected marker 3 and displays the identified image in the determined display position.

The marker 3 is therefore readily associated with the image data 31, whereby an image to be displayed on the screen SC can be readily changed.

The terminal apparatus 10 acquires image data 31 and generates the association information 35 that associates the acquired image data 31 with the marker information 33.

The terminal apparatus 10 can therefore change an image to be displayed by the projector 100.

The projector 100 causes the PJ storage 151 to store the image data 31 based on which an image is so generated in accordance with the association information 35 in such a way that the image is associated with the marker information 33.

The projector 100 acquires marker information 33 corresponding to the characteristics of the detected marker 3, acquires image data 31 associated with the acquired marker information 33 from the PJ storage 151, and displays the acquired image data 31.

The projector 100 can therefore display an image corresponding to the marker 3 disposed on the screen SC.

The projector 100 captures an image of the screen SC to generate a captured image, detects the marker 3 in the generated captured image, and detects the position and characteristics of the marker 3.

The position and characteristics of the marker 3 are therefore readily detected.

The projector 100 detects movement of the marker 3 based on a plurality of captured images and determines at least one of an image display position and a displayed image size based on the detected movement of the marker 3.

At least one of the image display position and the displayed image size can therefore be changed by moving the marker 3.

The terminal apparatus 10 acquires the marker information 33 from captured image data on a captured marker 3.

The marker information 33 can therefore be acquired in the simple configuration.

The marker information 33 contains the shape or color of an object used as the marker 3.

The marker 3 is therefore readily identified.

The marker 3 contains a QR code as the image code, and the marker information 33 contains information on a decoded image code.

The marker 3 is therefore more readily identified.

### Second Embodiment

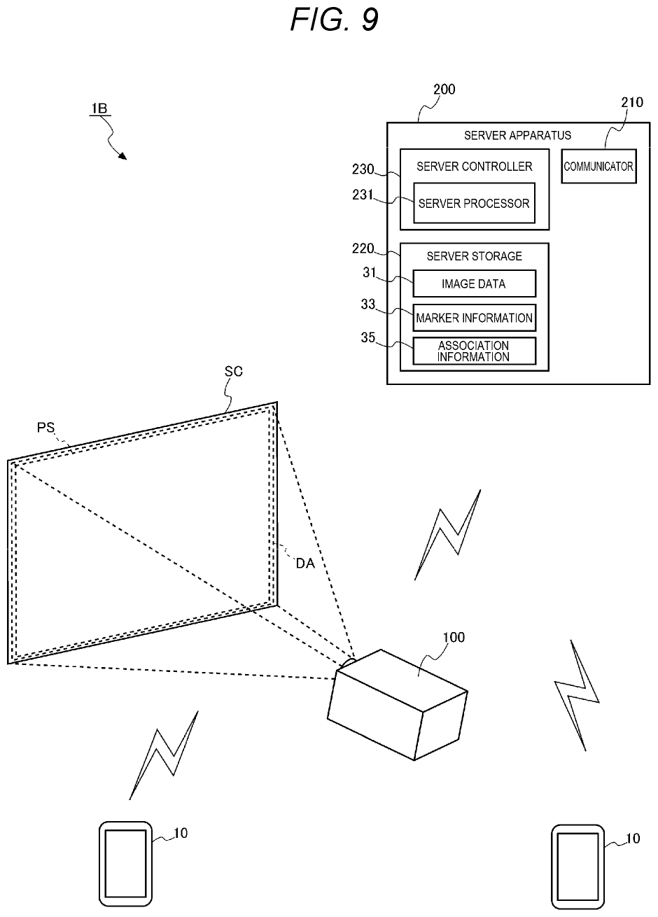

FIG. 9 shows the system configuration of a display system 1B according to a second embodiment.

The display system 1B according to the second embodiment includes a server apparatus 200 in addition to the terminal apparatus 10 and the projector 100. In the second embodiment, the server apparatus 200 corresponds to the “storage.”

The terminal apparatus 10 and the projector 100 are communicably coupled to the server apparatus 200. For example, the projector 100, the terminal apparatus 10, and the server apparatus 200 may be coupled to a single Wi-Fi access point. Wi-Fi is a registered trademark. Instead, the server apparatus 200 may be disposed as a component coupled to a communication network, such as the Internet, and the terminal apparatus 10 and the projector 100 may access the server apparatus 200 over the communication network.

In the second embodiment, the terminal apparatus 10 transmits the registration information containing the image data 31, the marker information 33, and the association information 35 to the server apparatus 200, and the registration information is registered in the server apparatus 200.

### 6. Configuration of Server Apparatus

The server apparatus 200 includes a communicator 210, a server storage 220, and a server controller 230. The communicator 210 allows data communication between the terminal apparatus 10 and the projector to be performed over the communication network.

The server storage 220 is formed, for example, of a hard disk drive. The server storage 220 stores the image data 31 and the marker information 33 with the data and the information associated with each other in accordance with the association information 35 received from the terminal apparatus 10.

The serves controller 230 includes a server processor 231. The server processor 231 executes a control program to control each portion of the server apparatus 200.

### 7. Action of Server Epparatus

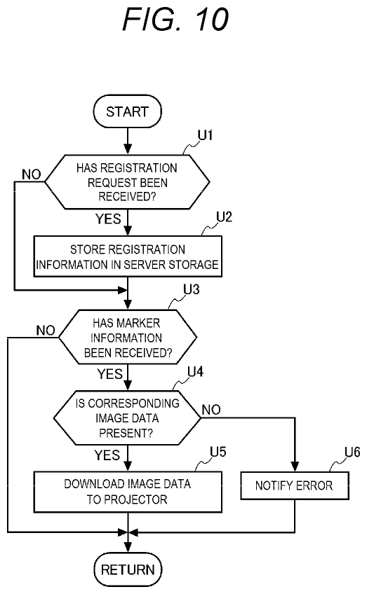

FIG. 10 is a flowchart showing the action of the server apparatus 200.

The action of the server apparatus 200 will be described with reference to FIG. 10.

The server controller 230 evaluates whether or not the request to upload registration information has been received from the terminal apparatus 10 (step U1). In a case where no request to upload registration information has been received (NO in step U1), the server controller 230 proceeds to evaluation in step U3. Ina case where the request to upload registration information has been received (YES in step U1), the server controller 230 receives registration information uploaded from the terminal apparatus 10. The server controller 230 causes the server storage 220 to store the image data 31 and the marker information 33 with the data and the information associated with each other in accordance with the association information 35 contained in the received registration information (step U2).

The server controller 230 then evaluates whether or not marker information 33 has been received from the projector 100 (step U3). In a case where no marker information 33 has been received (NO in step U3), the server controller 230 returns to the evaluation in step U1.

In a case where marker information 33 has been received (YES in step U3), the server controller 230 evaluates whether or not the image data 31 associated with the received marker information 33 is stored in the server storage 220 (step U4). In a case where the image data 31 is not stored in the server storage 220 (NO in step U4), the server controller 230 notifies the projector 100 of an error (step U6). In a case where the image data 31 is stored in the server storage 220 (YES in step U4), the server controller 230 downloads the relevant image data 31 to the projector 100 (step U5).

### 8. Action of Projector

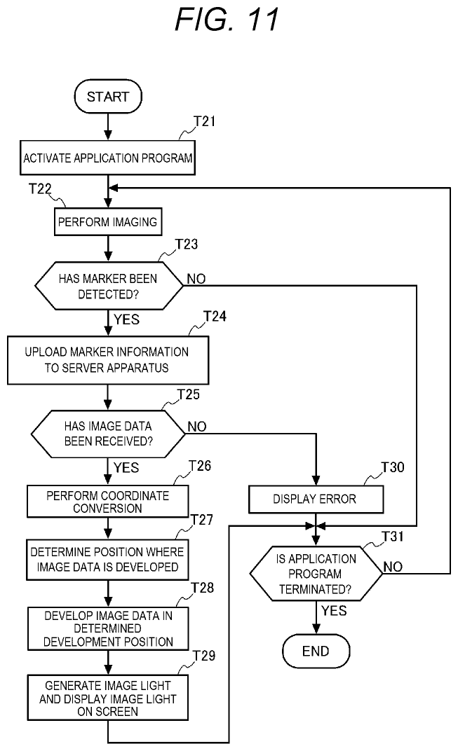

FIG. 11 is a flowchart showing the action of the projector 100.

The action of the projector 100 will be described with reference to the flowchart shown in FIG. 11.

When the remote control is so operated that an application program contained in the control program 152 is selected, the projector 100, specifically, the PJ controller 150 executes the selected application program. The application program is thus activated (step T21).

The PJ controller 150 causes the PJ imager 139 to perform imaging (step T22) to acquire captured image data. The PJ controller 150 analyzes the acquired captured image data to detect a marker 3 (step T23). The PJ controller 150 processes the captured image data to acquire code information. In a case where code information has been acquired, the PJ controller 150 determines that a marker 3 has been detected (YES in step T23). In a case where no code information has been acquired, the PJ controller 150 determines that no marker 3 has been detected (NO in step T23).

In the case where no marker 3 has been detected (NO in step T23), the PJ controller 150 proceeds to evaluation in step T31. In the case where a marker 3 has been detected (YES in step T23), the PJ controller 150 uploads the acquired code information as the marker information 33 to the server apparatus 200 (step T24). The PJ controller 150 then evaluates whether or not image data 31 has been received from the server apparatus 200 (step T25).

In a case where no image data 31 has been received from the server apparatus 200 (NO in step T25), the PJ controller 150 displays an error on the screen SC. The displayed error contains a message stating “No image data 31 has been associated with the marker 3.” The PJ controller 150 then proceeds to the evaluation in step T31.

In a case where image data 31 has been received (YES in step T25), the PJ controller 150 performs coordinate conversion of the imaging coordinates where the code information has been detected and which show the range of the captured image data into the memory coordinates based on the calibration data 153 (step T26).

The PJ controller 150 then determines the position in the frame memory 145 where the image data 31 is developed based on the size of the received image data 31 and the memory coordinates as a result of the coordinate conversion (step T27). The PJ controller 150 generates the memory coordinates in the frame memory 145 that represent the development position and outputs the generated memory coordinates and the image data 31 to the image processor 143.

The image processor 143 develops the inputted image data 31 at the memory coordinates in the frame memory 145 that have been inputted from the PJ controller 150 (step T28). In the case where a plurality of markers 3 are disposed on the screen SC and a plurality of sets of marker information 33 are detected from the captured image data, image data 31 associated with the other markers 3 are also developed in the frame memory 145. The image processor 143 reads the image data 31 developed in the frame memory 145 and outputs the read image data 31 to the light modulator driving circuit 123. Image light corresponding to the read image data 31 is then generated by the projection section 110 and projected on the screen SC (step T29).

The PJ controller 150 then evaluates whether or not operation of terminating the application program has been accepted. In a case where the operation of terminating the application program has been accepted (YES in step T31), the PJ controller 150 terminates the process procedure. In a case where no operation of terminating the application program has been accepted (NO in step T31), the PJ controller 150 returns to step T22 and acquires captured image data.

The embodiments described above are each a specific example to which the present disclosure is applied, and the present disclosure is not limited to the embodiments.

For example, the above embodiments have been described with reference to the case where the image data 31 is associated with a marker 3, but a marker 3 is not necessarily associated with the image data 31. For example, a marker 3 may be associated with an apparatus that outputs the image data 31 to the projector 100. Apparatus identification information is, for example, identification information that allows the projector 100 to identify the apparatus and may, for example, be a MAC address, an IP address, or a Bluetooth address.

The size and the projection position of the projection image 5 displayed on the screen SC may be set in association with the characteristics of the marker 3. The projector 100 determines the size and the projection position of the projection image 5 based on the color, pattern, shape, or size of the marker 3 detected in the captured image data, which are apparent characteristics of the marker 3. The projector 100 may instead determine the size and the projection position of the projection image 5 based on the detected code information.

In a case where the display position determined based on the position of the marker 3 does not fall within the projection area PA, the projector 100 may change the position in the frame memory 145 where the image data 31 is developed or the size of the image data 31. The projector 100 changes the position in the frame memory 145 where the image data 31 is developed or the size of the image data 31 in such a way that the image data 31 does not extend off the projection area PA.

The above embodiments have been described with reference to the case where the projector 100 optically detects the marker 3, but not necessarily. For example, the projector 100 may detect the marker 3 in the target range IA based on wireless communication. For example, the marker 3 may be formed of a Bluetooth tag, a beacon tag, or an RFID tag, and the projector 100 may detect the marker 3 by receiving a wireless signal from the marker 3.

The above embodiments have been described with reference to the case where the projector 100 accommodates the PJ imager 139 corresponding to the “detection apparatus,” but not necessarily. For example, a digital camera installed as a component external to the projector 100 may be used as the “detection apparatus” to capture an image of the marker 3 and transmit the resultant captured image data to the projector 100.

The above embodiments have been described with reference to the case where the target range IA coincides with the projection area PA, but not necessarily. The target range IA preferably contains part of the projection area PA but may not coincide with the projection area PA, and the target range IA may contain the projection area PA and therearound, or part of the projection area PA may form the target range IA.

The display apparatus according to the present disclosure is not limited to the projector 100. For example, a liquid crystal monitor or a liquid crystal television that displays an image on a liquid crystal display panel maybe used as the display apparatus, or an OLED (organic light-emitting diode) display, an OEL (organic electro-luminescence) display, or any other similar display may be used as the display apparatus. The present disclosure is also applicable to an apparatus using another display method.

The functional portions of the terminal apparatus 10 shown in FIG. 2 and the projector 100 shown in FIG. 3 each represent a functional configuration and is not necessarily implemented in a specific form. That is, hardware corresponding to each of the functional portions is not necessarily implemented, and a single processor that executes a program can, of course, achieve the functions of the plurality of functional portions. Further, a plurality of processors may cooperate with one another to achieve the functions of one or more of the functional portions. Further, part of the functions achieved by software in the embodiments described above may be achieved by hardware, or part of the functions achieved by hardware may be achieved by software. In addition, the specific detailed configuration of each of the other portions in the display system 1 can be arbitrarily changed to the extent that the change does not depart from the substance of the present disclosure.

In a case where the display method is achieved by using a computer, a program executed by the computer can be configured in the form of a recording medium or a transmission medium that transmits the program. The recording medium can be a magnetic or optical recording medium or a semiconductor memory device. Specific examples of the recording medium may include a flexible disk, an HDD (hard disk drive), a CD-ROM (compact disk read only memory), a DVD, a Blu-ray Disc, a magneto-optical disk, a flash memory, and a portable or immobile recording medium, such as a card-shaped recording medium. The recording medium described above may instead be a RAM (random access memory), a ROM (read only memory), an HDD, or any other nonvolatile storage device provided in the projector 100. Blu-ray is a registered trademark.

The process units in the flowcharts shown in FIGS. 7, 8, 10, and 11 are process units divided in accordance with the contents of the primary processes for easy understanding of the processes carried out by the terminal controller 20, the PJ controller 150, and the server controller 230. How to generate the divided process units or the names of the process units shown in the flowcharts of FIGS. 7, 8, 10, and 11 do not limit the present disclosure. Processes carried out by the terminal controller 20, the PJ controller 150, and the server controller 230 can each be further divided into a larger number of process units in accordance with the content of the process, and the process units can further be each divided into a large number of processes. Further, the orders in which the processes are carried out in the flowcharts described above are not limited to those shown in FIGS. 7, 8, 10, and 11.

What is claimed is:

1. A display method comprising:
causing a terminal apparatus to acquire marker information representing a characteristic of a marker;
causing the terminal apparatus to generate association information that associates a display target image with the marker information;
causing a detection apparatus to detect the marker disposed on a display surface;
causing a display apparatus to extract the characteristic of the detected marker and identify an image associated with the marker based on the marker information corresponding to the extracted characteristic and the association information;
causing the display apparatus to determine a position where the image is displayed based on a position of the detected marker; and
causing the display apparatus to display the identified image in the determined display position.

2. The display method according to claim 1, wherein the terminal apparatus acquires image data based on which the image is formed and generates the association information that associates the acquired image data with the marker information.

3. The display method according to claim 2,
wherein the display apparatus acquires the marker information corresponding to the extracted characteristic of the marker, and
the display apparatus acquires the image data associated with the acquired marker information from a storage that stores the image data in accordance with the association information in such a way that the image is associated with the marker information and displays the image data.

4. The display method according to claim 1,
wherein the detection apparatus captures an image of the display surface to generate a captured image, and
the display apparatus detects the marker in the generated captured image, extracts the characteristic of the marker, and detects the position of the marker.

5. The display method according to claim 4,
wherein the display apparatus detects movement of the marker based on a plurality of the generated captured images, and
the display apparatus determines at least one of the position where the image is displayed and a size of the displayed image based on the detected movement of the marker.

6. The display method according to claim 1, wherein the terminal apparatus acquires the marker information from a captured image containing an image of the marker.

7. The display method according to claim 1, wherein the marker information contains a shape or a color of an object used as the marker.

8. The display method according to claim 1, wherein the marker contains an image code, and the marker information contains information on a decoded code of the image code.

9. A display system comprising:
a terminal apparatus including an information acquirer that acquires marker information representing a characteristic of a marker and a generator that generates association information that associates a display target image with the marker information; and
a display apparatus including a display section that displays an image on a display surface, a detector that detects a position and a characteristic of the marker disposed on the display surface, and a controller that identifies an image associated with the marker based on the marker information corresponding to the detected characteristic of the marker and the association information, determines a position where the image is displayed based on the detected position of the marker, and displays the identified image in the determined display position.

10. The display system according to claim 9, wherein the terminal apparatus includes a data acquirer that acquires image data based on which an image is formed, and
the generator generates the association information that associates the marker information acquired by the information acquirer with the image data acquired by the data acquirer.

11. The display system according to claim 10, further comprising
a storage that stores the image data in accordance with the association information generated by the terminal apparatus in such a way that the image is associated with the marker information,
wherein the display apparatus acquires the marker information corresponding to the detected characteristic of the marker, acquires the image data associated with the acquired marker information from the storage, and displays the acquired image data.

12. The display system according to claim 9,
wherein the display apparatus includes an imager that captures an image of the display surface, and
the controller detects the marker in the captured image generated by the imager and detects the position and the characteristic of the marker.

13. The display system according to claim 12, wherein the controller detects movement of the marker based on a plurality of the captured images and determines at least one of the position where the image is displayed and a size of the displayed image based on the detected movement of the marker.

14. The display system according to claim 9,
wherein the terminal apparatus includes an imager, and
the information acquirer acquires the marker information from a captured image generated by the imager and containing the marker.

15. The display system according to claim 9, wherein the marker information contains a shape or a color of an object used as the marker.

16. The display system according to claim 9, wherein the marker contains an image code, and the marker information contains information on a decoded code of the image code.
